(19) United States
(12) Patent Application Publication
(10) Pub. No.: US 2024/0308776 A1
(43) Pub. Date: Sep. 19, 2024

(54) CONVEYOR FOR CONTAINER TRANSPORTING

(71) Applicant: Hebei Qinhuai Data Co., Limited., Zhangjiakou City (CN)

(72) Inventors: Binghua ZHANG, Zhangjiakou City (CN); Mingjiang LI, Zhangjiakou City (CN)

(21) Appl. No.: 18/595,500

(22) Filed: Mar. 5, 2024

(30) Foreign Application Priority Data
Mar. 15, 2023 (CN) 202310250490.X

(51) Int. Cl. B65G 21/12

(52) U.S. Cl. CPC B65G 21/12

(57) ABSTRACT

The present disclosure discloses a conveyor for container transporting, including a tractor. A right end of the tractor is fixedly connected to a connecting seat provided with a connecting mechanism, and the connecting mechanism is provided with a transport plate. A lower end of the transport plate is provided with a wheel carrier through a bearing, and the wheel carrier is provided with wheels. The transport plate is in contact with a container, and a positioning mechanism is arranged on the transport plate. The connecting mechanism includes a shaft seat, a shaft hole is provided on the shaft seat, a pin shaft is slidably connected into the shaft hole, and the pin shaft is slidably connected to the connecting seat.

### CROSSREFERENCE TO RELATED APPLICATION

This application claims priority to Chinese Patent Application No. 202310250490.X, titled “CONVEYOR FOR CONTAINER TRANSPORTING” and filed to the China National Intellectual Property Administration on Mar. 15, 2023, the entire contents of which are incorporated herein by reference.

### TECHNICAL FIELD

The present disclosure relates to the field of conveyor, and more particularly, to a conveyor for container transporting.

### BACKGROUND

Containers refer to large cargo containers with certain strength, stiffness, and specifications specifically designed for recycling use. By using the containers to transport goods, the goods can be directly loaded at consigners' warehouses and unloaded at consignees' warehouses. Furthermore, there is no need to take out the goods from the containers for reloading when changing vehicles or ships midway.

The containers generally need to be transported by conveyors. After being transported to a designated location, the containers need to be lifted by dedicated cranes, and then are transported to another designated location by other transport vehicles. At present, in the transportation process, transfer conveyors are generally used for the transportation. However, the transfer conveyors are mostly plate trailers, which are driven by tractors. The tractors cannot be driven away to transport a next container unless the current containers on transport plates are lifted, resulting in lower operating efficiency. In addition, due to lack of measures of properly positioning the containers, there is a risk of slipping of the containers.

### SUMMARY

The present disclosure provides a conveyor for container transporting, and is aimed at solving problems of lower operating efficiency and possible slipping of a container during transfer of the container.

A conveyor for container transporting provided according to an embodiment of the present disclosure includes a tractor, where a right end of the tractor is fixedly connected to a connecting seat provided with a connecting mechanism. The connecting mechanism is provided with a transport plate, a lower end of the transport plate is provided with a wheel carrier through a bearing, and the wheel carrier is provided with wheels. The transport plate is in contact with a container, and a positioning mechanism is arranged on the transport plate. The connecting mechanism includes a shaft seat, a shaft hole is provided on the shaft seat, a pin shaft is slidably connected into the shaft hole, and the pin shaft is slidably connected to the connecting seat. An annular groove is provided on the pin shaft, a clamp pin is slidably connected into the annular groove, the shaft seat is fixedly connected to a support rod, an outer side of the support rod is provided with a torsion spring, and the outer side of the support rod is rotatably connected to the clamp pin, the shaft seat is fixedly connected to a hinged seat. The hinged seat is hinged with a fixed seat, and the fixed seat is fixedly connected to the transport plate.

The positioning mechanism includes a support frame fixedly connected to interior of the transport plate. The support frame is internally provided with a threaded rod through a bearing, a square groove is provided inside the threaded rod, a square rod is slidably connected into the square groove, and a first spring is arranged inside the square groove. One end of the threaded rod is connected to the transport plate through the bearing, and other end of the threaded rod is fixedly connected to a turnplate. The turnplate is provided with a limit groove, a limit pin is fixedly connected into the transport plate, and the limit pin is slidably connected to the limit groove. An outer side of the threaded rod is connected to a movable seat through a thread, the movable seat is fixedly connected to a clamp holder, the clamp holder is slidably connected to the transport plate, and a positioning pin is slidably connected into the clamp holder. An outer side of the positioning pin is provided with a second spring, and the clamp holder is in contact with the container.

In the conveyor for container transporting of the present disclosure, a sliding chute is provided on the transport plate, and the movable seat is slidably connected into the sliding chute. A moving space is provided to the movable seat by designing the sliding chute.

In the conveyor for container transporting of the present disclosure, a positioning groove is provided on the container, and the positioning pin is slidably connected into the positioning groove. The container may be positioned by fitting the positioning groove with the positioning pin.

In the conveyor for container transporting of the present disclosure, one end of the torsion spring is fixedly connected to the shaft seat, and other end of the torsion spring is fixedly connected to the clamp pin. Through the design of the torsion spring, it has a torsional effect on the clamp pin.

In the conveyor for container transporting of the present disclosure, the outer side of the positioning pin is fixedly connected to a support ring, which is slidably connected to the clamp holder.

In the conveyor for container transporting of the present disclosure, one end of the first spring is fixedly connected to the square rod, and other end of the first spring is fixedly connected to the threaded rod. By designing the first spring, pressure can be exerted to the square rod.

In the conveyor for container transporting of the present disclosure, a plurality of the limit grooves are provided, and the plurality of limit grooves are annularly distributed on the turnplate. By designing the limit groove, it is easy to limit the turnplate by fitting the limit groove with the limit pin.

In the conveyor for container transporting of the present disclosure, one end of the second spring is fixedly connected to the clamp holder, and other end of the second spring is fixedly connected to a support ring. By designing the second spring, elastic force may be provided to the positioning pin, such that the positioning pin can clamp the positioning groove.

The technical solutions provided by the embodiments of the present disclosure may include following beneficial effects.

According to the solutions, by designing the connecting mechanism easy to disassemble, the tractor and the transport plate are convenient to disassemble, such that the tractor can quickly participate in operation of another transport plate after a previous operation is finished. That is, the tractor may immediately participate in transporting a next container, without waiting for the current container on the transport plate to be transferred. In this way, operating efficiency is improved.

According to the solutions, by designing the positioning mechanism, the container can be conveniently and quickly positioned, thereby preventing it from slipping. Moreover, the positioning mechanism is easy to adjust and adapt to containers with slightly different sizes, making it more applicable.

### BRIEF DESCRIPTION OF THE DRAWINGS

To describe the technical solutions of the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a schematic diagram of an overall structure according to the present disclosure;

FIG. 2 is an enlarged view of a connecting mechanism in FIG. 1 according to the present disclosure;

FIG. 3 is an enlarged view of a structure of Part A in FIG. 2 according to the present disclosure;

FIG. 4 is an enlarged view of a local structure in FIG. 1 according to the present disclosure;

FIG. 5 is an enlarged view of a structure of Part B in FIG. 4 according to the present disclosure; and

FIG. 6 is an enlarged view of a structure of Part C in FIG. 4 according to the present disclosure; and

### REFERENCE NUMERALS IN THE ACCOMPANYING DRAWINGS

tractor 1; connecting seat 2; connecting mechanism 3; shaft seat 31; shaft hole 32; pin shaft 33; annular groove 34; support rod 35; torsion spring 36; clamp pin 37; hinged seat 38; fixed seat 39; transport plate 4; sliding chute 5; wheel carrier 6; wheel 7; container 8; positioning groove 81; positioning mechanism 9; support frame 91; threaded rod 92; square groove 93; square rod 94; first spring 95; turnplate 96; limit groove 97; limit pin 98; movable seat 99; clamp holder 910; positioning pin 911; support ring 912; and second spring 913.

### DETAILED DESCRIPTION

Technical solutions in the embodiments of the present disclosure will be described clearly and completely below, in conjunction with the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It should also be understood that the terms used in this specification of the present disclosure are only for the purpose of describing particular embodiments and are not intended to limit the present disclosure. As used in the specification and the appended claims of the present disclosure, the singular forms of “a”, “an” and “the” may be intended to include the plural forms, unless the context clearly indicates otherwise.

It should also be further understood that the term “and/or” used in the specification and the appended claims of the present disclosure refers to any combination of one or more of the relevantly listed items and all possible combinations, and includes these combinations.

Referring to FIG. 1, a conveyor for container transporting includes a tractor 1. A right end of the tractor 1 is fixedly connected to a connecting seat 2. A connecting mechanism 3 is provided with a transport plate 4, a sliding chute 5 is provided on the transport plate 4, and a movable seat 99 is slidably connected into the sliding chute 5. A moving space is provided to the movable seat 99 by designing the sliding chute 5. A lower end of the transport plate 4 is provided with a wheel carrier 6 through a bearing, and the wheel carrier 6 is provided with wheels 7. The transport plate 4 is in contact with a container 8, a positioning groove 81 is provided on the container 8, and a positioning pin 911 is slidably connected into the positioning groove 81. The container 8 may be positioned by fitting the positioning pin 911 with the positioning groove 81.

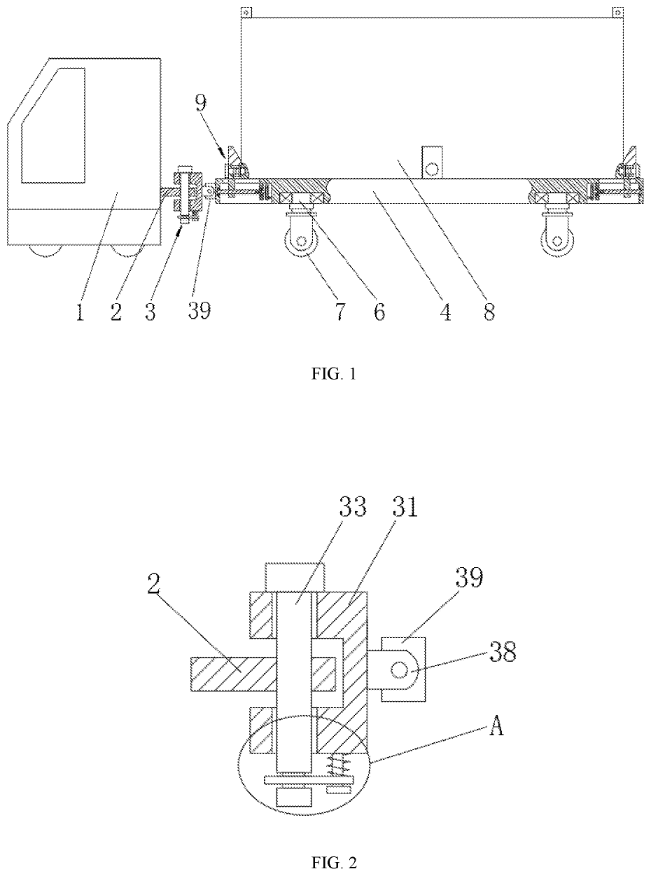

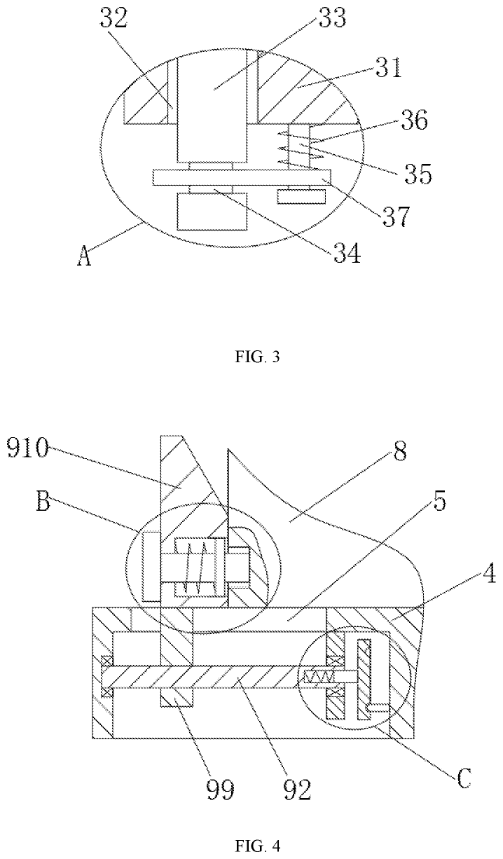

Referring to FIG. 1, FIG. 2, and FIG. 3, the connecting seat 2 is provided with the connecting mechanism 3, which includes a shaft seat 31, a shaft hole 32, a pin shaft 33, an annular groove 34, a support rod 35, a torsion spring 36, a clamp pin 37, a hinged seat 38, and a fixed seat 39. The shaft hole 32 is provided on the shaft seat 31, the pin shaft 33 is slidably connected into the shaft hole 32, and the pin shaft 33 is slidably connected to the connecting seat 2. The annular groove 34 is provided on the pin shaft 33, and the clamp pin 37 is slidably connected into the annular groove 34. The pin shaft 33 may be limited by fitting the annular groove 34 with the clamp pin 37. The shaft seat 31 is fixedly connected to the support rod 35, and an outer side of the support rod 35 is provided with the torsion spring 36. One end of the torsion spring 36 is fixedly connected to the shaft seat 31, and other end of the torsion spring 36 is fixedly connected to the clamp pin 37. The torsion spring 36 provides torsional force to the clamp pin 37, such that the clamp pin 37 is clamped into the annular groove 34. The outer side of the support rod 35 is rotatably connected to the clamp pin 37, and the shaft seat 31 is fixedly connected to the hinged seat 38. The hinged seat 38 is hinged with the fixed seat 39, and the fixed seat 39 is fixedly connected to the transport plate 4. By designing the connecting mechanism 3, it is convenient for the tractor 1 to connect the transport plate 4.

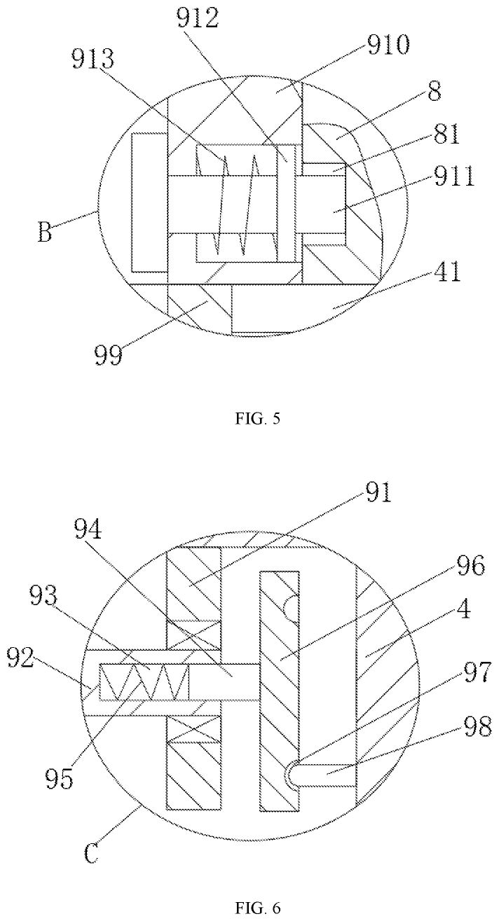

Referring to FIG. 1, FIG. 4, FIG. 5, and FIG. 6, the transport plate 4 is provided with a positioning mechanism 9, which includes a support frame 91, a threaded rod 92, a square groove 93, a square rod 94, a first spring 95, a turnplate 96, a limit groove 97, a limit pin 98, a movable seat 99, a clamp holder 910, a positioning pin 911, a support ring 912, and a second spring 913. The support frame 91 is fixedly connected to interior of the transport plate 4. The support frame 91 is internally provided with the threaded rod 92 through a bearing, the square groove 93 is provided inside the threaded rod 92, the square rod 94 is slidably connected into the square groove 93, and the first spring 95 is arranged inside the square groove 93. One end of the first spring 95 is fixedly connected to the square rod 94, and other end of the first spring 95 is fixedly connected to the threaded rod 92. One end of the threaded rod 92 is connected to the transport plate 4 through the bearing, and other end of the threaded rod 92 is fixedly connected to the turnplate 96. The turnplate 96 is provided with a plurality of limit grooves 97 annularly distributed on the turnplate 96. The limit pin 98 is fixedly connected into the transport plate 4, and the limit pin 98 is slidably connected to the limit groove 97. Thus, it is easy to limit the turnplate 96 by fitting the limit pin 98 with the limit groove 97.

Referring to FIG. 1, FIG. 4, FIG. 5, and FIG. 6, the outer side of the threaded rod 92 is connected to the movable seat 99 through a thread, the movable seat 99 is fixedly connected to the clamp holder 910, the clamp holder 910 is slidably connected to the transport plate 4, and the positioning pin 911 is slidably connected into the clamp holder 910. An outer side of the positioning pin 911 is fixedly connected to the support ring 912, and the support ring 912 is slidably connected to the clamp holder 910. The outer side of the positioning pin 911 is provided with the second spring 913. One end of the second spring 913 is fixedly connected to the clamp holder 910, and other end of the second spring 913 is fixedly connected to the support ring 912, and the clamp holder 910 is in contact with the container 8. By designing the support ring 912 and the second spring 913, the second spring 913 may provide elastic force to the support ring 912, such that the positioning pin 911 can be clamped into the positioning groove 81.

Specific implementation processes of the present disclosure are as follows. When it is required to separate the tractor 1 from the transport plate 4, the clamp pin 37 is pushed outward, such that the clamp pin 37 rotates around the support rod 35 and leaves from the annular groove 34 of the pin shaft 33, thereby releasing the limit on the pin shaft 33. Next, the pin shaft 33 is pulled out of the shaft seat 31. In this way, the tractor 1 can be separated from the connecting mechanism 3, and thus can be separated from the transport plate 4. After that, the tractor 1 may be driven away to transport a next container 8. In this way, operating efficiency is improved.

When it is required to position the container 8, the container 8 is lifted onto the transport plate 4, and then the turnplate 96 is pushed towards the support frame 91, causing the turnplate 96 to leave from the limit pin 98, such that the turnplate 96 drives the square rod 94 to slide and compress the first spring 95. Next, the turnplate 96 is rotated, such that the turnplate 96 drives the square rod 94 to rotate, the square rod 94 drives the threaded rod 92 to rotate, causing threaded movement between the threaded rod 92 and the movable seat 99 and thus generating a relative displacement, which causes the movable seat 99 to drive the clamp holder 910 to move, making the clamp holder 910 close to the container 8, and the positioning pin 911 on the clamp holder 910 is clamped into the positioning groove 81 on the container 8. In this way, the container 8 can be positioned to prevent it from slipping. Due to the adjustable design of the clamp holder 910, the clamp holder 910 can adapt to containers 8 with different sizes and thus has better applicability. When it is required to lift the limit on the container 8, the positioning pin 911 is pulled to allow the positioning pin 911 to leave from the positioning groove 81.

The preceding descriptions are merely specific embodiments of the present disclosure, but are not intended to limit the protection scope of the present disclosure. Any equivalent modifications or replacements easily conceivable to a person of skilled in the art within the technical scope disclosed in the present disclosure shall fall within the protection scope of the present disclosure. Therefore, the protection scope of the present disclosure shall be subject to that of the claims.

What is claimed is:

1. A conveyor for container transporting, comprising a tractor, a right end of the tractor being fixedly connected to a connecting seat provided with a connecting mechanism, the connecting mechanism being provided with a transport plate, a lower end of the transport plate being provided with a wheel carrier through a bearing, the wheel carrier being provided with wheels, the transport plate being in contact with a container, and a positioning mechanism being arranged on the transport plate, wherein the connecting mechanism comprises a shaft seat, a shaft hole is provided on the shaft seat, a pin shaft is slidably connected into the shaft hole, the pin shaft is slidably connected to the connecting seat, an annular groove is provided on the pin shaft, a clamp pin is slidably connected into the annular groove, the shaft seat is fixedly connected to a support rod, an outer side of the support rod is provided with a torsion spring, the outer side of the support rod is rotatably connected to the clamp pin, the shaft seat is fixedly connected to a hinged seat, the hinged seat is hinged with a fixed seat, and the fixed seat is fixedly connected to the transport plate; and
the positioning mechanism comprises a support frame fixedly connected to interior of the transport plate, the support frame is internally provided with a threaded rod through a bearing, a square groove is provided inside the threaded rod, a square rod is slidably connected into the square groove, and a first spring is arranged inside the square groove, one end of the threaded rod is connected to the transport plate through the bearing, other end of the threaded rod is fixedly connected to a turnplate, the turnplate is provided with a limit groove, a limit pin is fixedly connected into the transport plate, the limit pin is slidably connected to the limit groove, an outer side of the threaded rod is connected to a movable seat through a thread, the movable seat is fixedly connected to a clamp holder, the clamp holder is slidably connected to the transport plate, a positioning pin is slidably connected into the clamp holder, an outer side of the positioning pin is provided with a second spring, and the clamp holder is in contact with the container.

2. The conveyor for container transporting according to claim 1, wherein a sliding chute is provided on the transport plate, and the movable seat is slidably connected into the sliding chute.

3. The conveyor for container transporting according to claim 1, wherein a positioning groove is provided on the container, and the positioning pin is slidably connected into the positioning groove.

4. The conveyor for container transporting according to claim 1, wherein one end of the torsion spring is fixedly connected to the shaft seat, and other end of the torsion spring is fixedly connected to the clamp pin.

5. The conveyor for container transporting according to claim 1, wherein the outer side of the positioning pin is fixedly connected to a support ring, and the support ring is slidably connected to the clamp holder.

6. The conveyor for container transporting according to claim 1, wherein one end of the first spring is fixedly connected to the square rod, and other end of the first spring is fixedly connected to the threaded rod.

7. The conveyor for container transporting according to claim 1, wherein a plurality of the limit grooves are provided, and the plurality of limit grooves are annularly distributed on the turnplate.

8. The conveyor for container transporting according to claim 1, wherein one end of the second spring is fixedly connected to the clamp holder, and other end of the second spring is fixedly connected to a support ring.
